(19) United States
(12) Patent Application Publication
(10) Pub. No.: US 2008/0178642 A1
(43) Pub. Date: Jul. 31, 2008

(54) Semirigid motorcycle saddlebag universal lock assemby

(76) Inventor: Dean Sanders, Stockton, CA (US)

Correspondence Address: Matlock Law Group, 1485 Treat Blvd, Suite 200, Walnut Creek, CA, 94597, US

(21) Appl. No.: 11/699,757

(22) Filed: Jan. 29, 2007

(51) Int. Cl. E05B 65/52

(52) U.S. Cl. 70/64

(57) ABSTRACT

A road saddlebag universal, self-aligning locking latch and receptacle assembly mechanism for a semi-rigid saddlebag assembly for a variety of road bike, motorcycle styles. It provides a toothed pawl, lock and receiver, self-aligning latch and keyed lock mechanism to provide secure, tamper proof locking functionality to the semi-rigid saddlebag high security motorcycle and rider gear stowage. It also provides a method for providing universal, self-aligning locking latch and receptacle assembly mechanism for a semi-rigid saddlebag assembly for a variety of road bike, motorcycle styles. It also provides a spring loaded pawl receiver, self-aligning mechanism with toothed pawl latch functionality guided into a lower pawl engagement receiver providing a full encapsulation of traveling pawl receiver. It can be easily adapted to various designs of the road bike, motorcycle saddlebag, gear stowage compartments. The security locking system is not dependent upon a particular design style. It provides tamperproof lock and latch mechanism apparatus security by utilizing the traveling toothed latch fully encapsulating the toothed pawl within the self-aligning receptacle and tamper restricting lock guard cover of the lock mechanism. It provides resistance to the collapse and/or deformation of the semi-rigid leather saddlebag in order to defeat the integrity of the locking mechanism.

### BACKGROUND

1. Field of the Disclosure

The present disclosure relates to semi-rigid, leather or similar semi-rigid material saddlebags aftermarket accessories for a multiplicity of style motorcycle road bikes and accessory bag designs. More particularly, the present disclosure is a universal, self-aligning locking latch and receptacle assembly mechanism for a semi-rigid saddlebag assembly for a variety of road bike storage bag styles. The subject matter herein relates generally to a toothed pawl, lock and receiver, self-aligning latch and keyed lock mechanism to provide secure, tamper proof locking functionality to the semi-rigid motorcycle bag. Further, the subject matter also relates generally to a received pawl and, self-aligning lock housing receiver mechanism with pawl latch functionality guided into a lower pawl engagement receiver and lock providing a full encapsulation of traveling locking pawl which engages the housed lock mechanism for a multiplicity of locking locations allowing the bag to be locked in the fully closed or less than fully closed position.

2. The Prior Art

Background

Semi-rigid motorcycle road-bike saddlebags are well known in the art. The most common type of such saddlebags includes a non-locking pouch for the stowage of rider's gear. The popular configuration of the non-locking pouch does not include a locking mechanism but rather provide latched or buckled straps to secure the contents of the bag. Further, a locking saddlebag is also well known in the art, specifically push-button, lock hasp and lock hasp and hinge styles, none of these locking mechanisms allow the user to lock the bag in various locking positions which allows the bag to be locked in while in a less than fully closed, or an “overfilled” position. The present embodiment of the universal locking for semi-rigid road bike saddlebags, provides a novel, high security locking mechanism while maintaining the current shaped, semi-rigid construction of the manufacturer's original design. In one embodiment of the present disclosure, a toothed traveling pawl mechanism is provided for the hinged cover of the semi-rigid bag, and a lock housing and receiver which provides proper alignment and lock engagement of the locking pawl. No such high security and self-aligning locking and latching mechanism feature is currently found in present designs. Moreover, motorcycle riders have long felt the need for a semi rigid motorcycle bag locking mechanism that retains the bike's semi-rigid construction and functional shape while simultaneously providing secure, lockable, tamper proof functionality to enhance the privacy and security of a plurality of externally mounted saddlebag assemblies. The toothed traveling pawl latch and keyed lock mechanism provides secure, tamper proof universal locking functionality to the semi-rigid saddlebags in a plurality of saddlebag constructions being made of leather or other semi rigid materials, or with the addition polymer or other rigidity increasing materials. Further, the toothed traveling pawl latch and aligning lock receptacle provides a full encapsulation of the upper mating strike, toothed traveling pawl and facilitating proper alignment and preventing entry or circumvention of the lock mechanism or defeating of the latch receptacle because of the semi-rigid nature of the leather saddlebag. The result is an improvement to the typical problem of locking mechanisms on such semi-rigid motorcycle stowage compartments typically referred to as saddlebags. Road bike, motorcycle users have long felt the need for a higher security, tamperproof design to lock and stow articles within the semi-rigid motorcycle bags, as existing designs do not allow for misalignment nor a multiplicity of locked positions between the fixed lock and the locked component attached to the hinged bag cover.

### BRIEF DESCRIPTION OF THE DRAWING FIGURES

FIG. 1 is a front view of a typical closed saddlebag with the various components and bill of material for a latch and lock assembly.

FIG. 2 is a view of the various components and bill of material for a toothed traveling pawl, enclosed self-aligning receptacle and lock assembly within a front view of a typical closed alternate typical second style of saddlebag.

FIG. 3 is a front view of a typical first style saddlebag with top, hinged cover and fastened, hinged, and spring-loaded, toothed traveling pawl and self-aligned receptacle and lock mechanism for a plurality of top cover and saddlebag shapes and sizes using the said first style design and spring loaded, hinged latch lever.

FIG. 4 is a side view illustration for the rotating, hinged action and spring loaded, toothed pawl, concealed latch assembly and corresponding external key locking mechanism with the top cover in its fully extended upright position.

FIG. 5 is a side view illustration for the rotating, hinged action and spring loaded, toothed pawl, concealed latch assembly and corresponding external key locking mechanism with the top cover in a partially closed and latched position.

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

The present disclosure relates to semi-rigid, leather covered saddlebags aftermarket accessories for a multiplicity of style motorcycle road bikes. More particularly, the present disclosure is a universal, self-aligning locking latch and receptacle assembly mechanism for a semi-rigid saddlebag assembly for a variety of road bike, motorcycle styles. The subject matter herein relates generally to a toothed pawl, lock and receiver, self-aligning latch and keyed lock mechanism to provide secure, tamper proof locking functionality to the semi-rigid saddlebag. Further, the subject matter also relates generally to a spring loaded pawl receiver, self-aligning mechanism with toothed pawl latch functionality guided into a lower pawl engagement receiver providing a full encapsulation of traveling toothed pawl.

Accordingly, it is a primary object of the present invention to provide a multiplicity of motorcycle road saddlebag designs with a universal, common style lock and latch assembly apparatus.

It is yet another object of this invention to provide a means for providing universal, common style universal lock and latch featuring high security motorcycle rider gear stowage for semi-rigid saddlebags.

It is yet another object of this invention to provide a method for providing universal design and high security locking feature on a multiplicity of road saddlebags.

It is yet another object of this invention that it can be easily adapted to various types of semi-rigid saddlebag designs of the specific road bike, motorcycles and that the security locking system is not dependant upon a particular brand of semi-rigid stowage compartment.

It is yet another object of this invention to provide tamperproof lock and latch mechanism apparatus security by utilizing the universal, self-aligning locking latch and receptacle assembly mechanism and tamper restricting lock guard cover of the lock mechanism.

It is yet another object of this invention to provide a means for resisting tampering and defeating of the lock mechanism through collapsing or deforming the semi-rigid leather saddlebag in order to defeat the integrity of the locking mechanism.

It is yet another object of this invention to provide a means to engage the traveling pawl and lock in multiple positions of a hinged bag cover without requiring the user to adjust the pawl and lock mechanism.

To attain these objects, the present invention discloses a motorcycle road storage bag a universal, self-aligning locking latch and receptacle assembly mechanism for semi-rigid saddlebags for a variety of road bike, motorcycle styles. The subject matter herein relates generally to a toothed pawl, lock and receiver, self-aligning latch and keyed lock mechanism to provide secure, tamper proof locking functionality to the semi-rigid saddlebag. Further, the subject matter also relates generally to a spring loaded pawl receiver, self-aligning mechanism with a traveling toothed pawl latch functionality guided into a lower pawl locking engagement receiver providing a full encapsulation of traveling toothed pawl. The locking mechanism device of the present disclosure comprises a distinctive and universal design that is held to the toothed traveling pawl by a self-aligning lock latching receptacle enclosure at a specific horizontal location and orientation on a first end and ratchets into place through a series of toothed notches and spring loaded locking pawl on the second end. The reverse spring biased toothed traveling pawl pivots about a mounting base securely fastened to a hinged top cover by a multiplicity of fastening means. The self-aligning, toothed receiving locking pawl and receptacle locking mechanism and cover-plate are secured and flush to the inside front panel pouch or body of the saddlebag. Suitable locking means include, but are not limited to a keyed, locking pawl assembly and a matching interoperable toothed traveling pawl latch mechanism mounted to the interior of the road saddlebag assembly by means of a base securely fastened therein. Generally these types of locking mechanisms require the user to properly orient the device to be effected during locking procedure due to the semi-rigid nature of the motorcycle bag. However, the current disclosure describes a self-aligning traveling, toothed pawl allowing a multiplicity of locking depth without requiring the user to align the hinged cover traveling portion and the lower fixed portion of the locking mechanism in their final locked positions.

According to the teaching of the invention, the road saddlebag universal lock aftermarket lock and latch assembly for a saddlebag apparatus securely locks a road bike, motorcycle storage bag of a multiplicity of specific styles and designs by means of a swivel concealed visual indication of the alignment of an interior toothed pawl latch and a high security locking key which is caused to move by any suitable means, to allow for pivot action indication of the toothed traveling pawl to the self-aligning receptacle locking mechanism and a means to open a locked saddlebag to gain access to the road bike, motorcycle and rider gear.

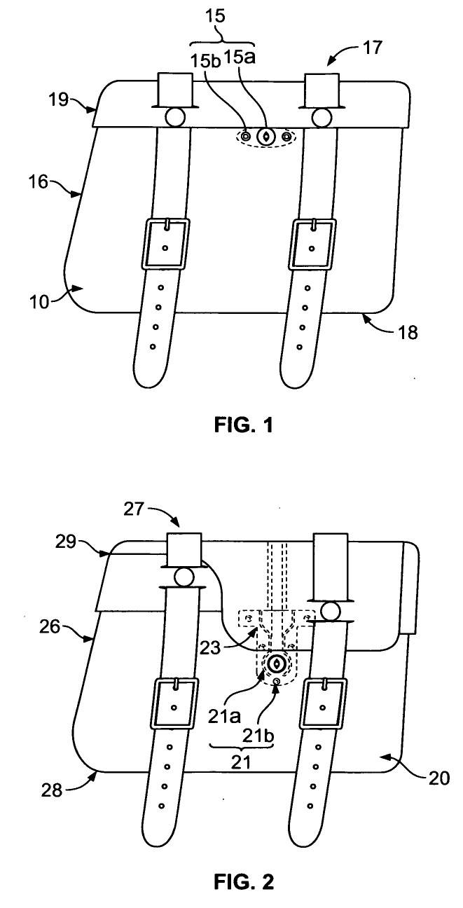

FIG. 1 is a front view of a typical closed saddlebag with the various components and bill of material for a latch and lock assembly.

One typical saddlebag construction shown in front view 10 includes a semi-rigid cavity surrounded by a substantially rectangular box shaped semi-rigid polymer or leather type material saddlebag 16 with a leather or similar hinge operation, top cover panel with a short cover lid wherein leather strap 17 hinged top cover lid 19 fully overlaps the upper portion of a front panel, first side panel, rear panel, and second panel; said front panel, first side panel, rear panel and second side panel form a continuously sewn, leather substantially perpendicular corner with a substantially rectangular bottom panel 14; said front panel includes a die-cut or punched preparation hole for a front panel visible lock and rivet assembly 15 wherein said lock and rivet assembly includes a key lock mechanism front view with key locking mechanism 15a and top portion of said rivet 15b wherein said lock is fastened to a mounting base on said interior cavity of semi-rigid rectangular, box shaped saddlebag.

FIG. 2 is a front view of a second typical closed saddlebag with the various components and bill of material for a latch and lock assembly associated with locking an overlapping tall top cover panel demonstrating one universal feature of the locking system comprised herein.

FIG. 2 also discloses an exploded view of the various components and bill of material for a toothed traveling pawl, enclosed self-aligning receptacle and lock assembly within a front view of a typical closed alternate typical second style saddlebag.

A second typical closed saddlebag construction shown in front view 20 includes a semi-rigid cavity surrounded by a substantially rectangular box shaped leather saddlebag 26 with typical leather strap buckle cover retaining assembly, fastened to an upper hinged top cover panel with an overlapping tall top panel cover lid wherein leather strap 27 hinged top cover lid 29 the upper portion of a front panel, first side panel, rear panel, and second panel; said front panel, first side panel, rear panel and second side panel form a continuously sewn, leather substantially perpendicular corner with a substantially rectangular bottom panel 28; said front panel includes a die-cut or punched preparation hole for a front panel visible lock and rivet assembly 21 wherein said lock and rivet assembly includes a key lock mechanism front view with locking cam 21a and a top portion of said rivet 21b wherein said rivet is fastened to a mounting base 22 of a latch and lock assembly on said interior cavity of semi-rigid rectangular, box shaped saddlebag; said closed saddlebag top lid cover with overlapping tall top panel cover lid conceals an interior mounting base 22 and receiver, self-aligning receptacle latch device 23 and mating self locating toothed pawl striker component.

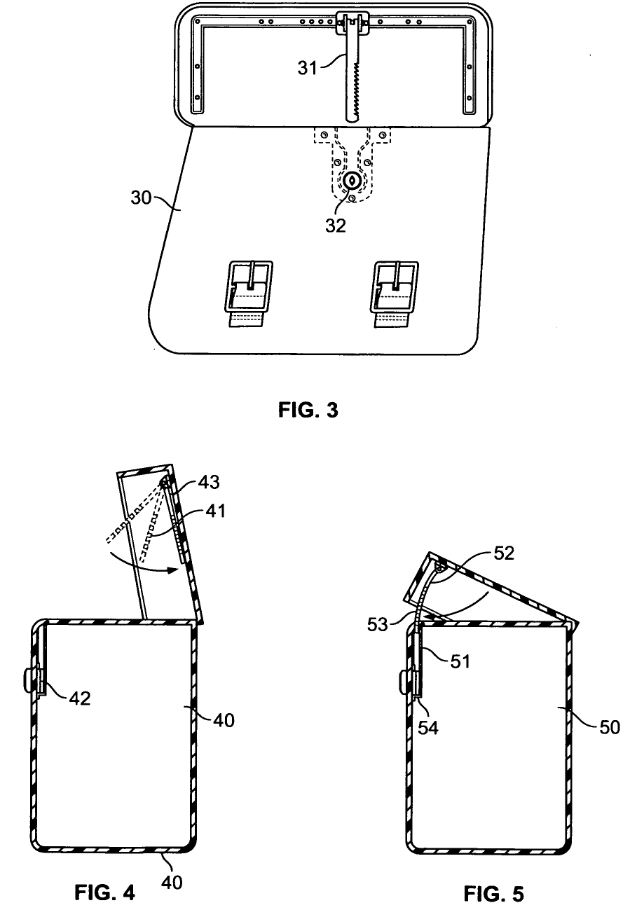

FIG. 3 is a front view of a typical first style saddlebag with top, hinged cover open 30 and fastened, pivoting, and spring-loaded, toothed traveling pawl 31 and self-aligning lock receiver receptacle 32 and lock mechanism assembly 15 for a plurality of top cover and saddlebag shapes and sizes using the said first style design and spring loaded, pivoting latch pawl 31.

The pivoting latch pawl must be horizontally aligned with the lower lock and receiver guide. The pivoting latch pawl is guided to the large pre-alignment channel of the pawl receiver of the lock assembly to allow the pivoting latch pawl to then be self aligned into the lower spring biased locking pawl and key lock assembly thus becoming fully encapsulated by the front and rear receiver guide plates providing tamperproof locking of the semi-rigid saddlebag. The moving pivoting toothed latch will then lock the cover at any closed position encompassed by the length of the toothed pawl.

FIG. 4 is a side view illustration for the rotating, pivot action and spring loaded, toothed pawl operation 41, concealed latch assembly side view 42 and corresponding external key locking mechanism with the top cover in its fully extended upright position wherein said spring loaded, toothed pawl striker is biased in the fully retracted, closed position to hold pawl against hinged top after removal of said pawl striker from said self locating, receiver receptacle and opening of hinged top cover to its fully extended upright position 43, wherein said user provides initial seating of toothed pawl striker into said self locating, receiver receptacle.

FIG. 5 is a side view illustration 50 for the rotating, hinged, pivot action and spring loaded, toothed pawl 31, concealed latch assembly and corresponding external key locking mechanism 15 with the top cover and corresponding receptacle and pawl assembly 54 in its partially closed and latched position, further illustrating the toothed pawl self locating and adjustable feature 52 and self locating receptacle operation 51 wherein a user pulls pawl down and initially seats said toothed pawl into self locating and self aligning receptacle receiver to align said pawl with said receiver to engage lock assembly mechanism.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims. The disclosure therefore teaches a means for providing key locking feature and high security motorcycle and rider gear stowage in a multiplicity of semi-rigid motorcycle gear stowage bags and lock designs.

It is yet another object of this invention that it can be easily adapted to various types of stylistic cover plates for concealing the externally viewable components of the lock mechanism, such as branded emblems with designs of the specific faceplate logo, and classic road bike, motorcycle designs and that the security locking system is not dependent upon the presence of a cover plate, nor branded cover plate emblem.

It is yet another object of this invention to provide tamper resistant or tamperproof lock and latch mechanism apparatus security system by utilizing a multiplicity of pivoting pawl and lock styles which may incorporate toothed pawl and spring biased locking pawl locking mechanisms as described in the present embodiment of the invention, or alternate systems which provide a single final locking position or a multiplicity of lock positions which allow the semi-rigid bag to be closed and latched in a multiplicity of hinged cover to fixed lower bag positions.

It is yet another object of this invention to provide a means for resisting tampering and defeating of the lock mechanism through collapsing or deforming the semi-rigid leather saddlebag in order to defeat the integrity of the locking mechanism.

1. A universal lock and latch assembly apparatus for semi-rigid motorcycle saddlebags comprising:
a recessed lock and latch mechanism providing a universal lock design and a concealed locking and latching mechanism providing high security protection for contents of said saddlebags.

2. The apparatus of claim 1 further comprising:
a pivoting movable pawl, fastened mounting base, and recessed, universal lock and latch mechanism allowing the lid and lower compartment of semi-rigid motorcycle gear stowage compartments to be locked in multiple vertical positions when overfilled, and thus less than fully closed.

3. The apparatus of claim 1 further comprising:
a locking and latching means for providing a universal locking feature and high security motorcycle and rider gear stowage.

4. The apparatus of claim 2 wherein
said universal locking and latching mechanism consisting of a key lock receptacle and toothed pawl assembly interlocked to a self-aligning receptacle and latch locking assembly.

5. A method for providing universal a high security locking feature on a road saddlebag assembly, comprising the steps of:
concealing said locking and latching mechanism from visible access indication, and
preventing improper access to the saddlebag, and
providing said universal and self-aligning latching and locking mechanism consistent with a multiplicity of semi-rigid motorcycle saddlebag designs, and facilitating a high security locking mechanism
wherein the proper stowage of gear in said saddlebags without regard to deformation of the semi-rigid saddlebag is allowed.

6. The apparatus of claim 2 wherein
said toothed movable pawl and self-aligning latch receptacle mechanism and security keyed mechanism are suitably connected to provide a means to receive a suitably designed entrapment of the movable toothed pawl and self-aligning latch receptacle thus preventing the rotating keyed pawl from interlocking with said movable toothed pawl, thereby preventing the movable toothed pawl from being dislodged from the receiving self-aligning receiver receptacle locking and latching mechanism as embodied on semi-rigid motorcycle road saddlebags and stowage compartments.

7. The apparatus of claim 1 wherein
the aesthetics of the locking mechanism are independent of the universal lock and latch key guard cover and striker stud security system as used on semi rigid road saddlebags.
